(19) United States
(12) Patent Application Publication
(10) Pub. No.: US 2008/0046317 A1
(43) Pub. Date: Feb. 21, 2008

(54) Systems and methods for predicting the efficacy of a marketing message

(75) Inventors: Alfred Christianson, Roswell, GA (US); Magracia Bernardino Lenon, Cincinnati, OH (US); Steven M. Levin, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company, Cincinnati, OH (US)

(21) Appl. No.: 11/508,031

(22) Filed: Aug. 21, 2006

(51) Int. Cl. G06Q 30/00

(52) U.S. Cl. 705/14

(57) ABSTRACT

Systems and methods for predicting the efficacy of a marketing message to generate word of mouth (WOM) are disclosed. A prediction server may generate and distribute surveys to a subset of a target market group. The prediction server may then analyze the survey responses and compare the responses to past responses for marketing messages in similar product or service categories. One or more scores relating to the message's ability to generate WOM may then be computed. These scores may reflect purchase intent, message advocacy, and message amplification of the marketing message. The marketing message may then be refined based on the value of the one or more scores. The prediction server may also access in-market data in order to project volume build or equity build of a promotional item associated with the marketing message.

### FIELD OF THE INVENTION

This invention relates generally to marketing campaigns and marketing messages and, more particularly, to systems and methods for analyzing and predicting the efficacy of a marketing campaign or marketing message to generate word of mouth within social networks.

### BACKGROUND OF THE INVENTION

Word of mouth (“WOM”), or interpersonal communication, may come in many forms, including personal recommendations, testimonials, and gossip. WOM often spreads through various social ties between members of a social group. Some of these ties may be strong ties (e.g., the social ties between close friends), where WOM may spread freely and quickly. Other ties may be relatively weak ties (e.g., the social ties between co-workers), where WOM may spread more slowly and may be met with reservation. In the marketing realm, there is little doubt that WOM spread through strong social ties is extremely valuable to the successful launch of a new product or service.

WOM marketing may differ significantly from traditional marketing techniques in that the marketing message used may be designed to meet a different set of criteria. For example, a mass media marketing message typically is designed to reach the largest number of potential consumers, whereas a WOM message may be designed to be highly talkable within a target social network or a target group of social networks. A WOM message may also be designed to meet other important criteria. For example, the message may be easily incorporated into dialogue and discussion (both oral and electronic) or be a conversation starter. These attributes may allow a WOM message to spread more quickly through highly-influential information brokers within and between social networks.

One reason why WOM is so valuable to marketers is because WOM is considered to carry the highest degree of credibility among consumers. For example, potential consumers are typically more inclined to believe a WOM promotion than more formal forms of promotion. In addition, WOM is sometimes spread through a consumer's own trusted social networks rather than through paid advertisers, who have little or no personal connection to the consumer. Consumers are more easily influenced by personal opinions spread through trusted networks of communication than by corporate rhetoric disseminated through traditional mass media.

The amount of WOM or “buzz” generated by a marketing campaign may be a critical factor in deciding whether to continue development of a product or service into a full-fledged consumer offering. Since WOM marketing can influence the rate of consumer awareness and adoption, some consumer offerings that do not generate sufficient WOM may have a difficult time sustaining themselves in the market. WOM advocacy can be an important driver of consumer behavior, and it may also be an indicator of the sustaining success of a product or service in the marketplace. This may be particularly true for products or services relying heavily or exclusively on social networking to help drive consumer interest and purchase intent. Thus, it is crucial to have an accurate analysis of the social ties within a target market group and a reliable projection of a marketing campaign's ability to generate WOM within that target market group.

WOM is becoming an increasingly important marketing technique in part because advertisers are having a difficult time reaching target consumers through traditional forms of media. In the past, a single television campaign could reach a large majority of consumers within a target market. Today, the same television campaign may reach only a small fraction of the campaign's target market. This may be due, in part, because of the growing selection of media content accessible through standard media equipment. In addition, today's technologically-savvy consumer pays less attention to advertising and marketing disseminated through traditional forms of media, such as broadcast television, and more attention to alternative forms of media, such as on-demand and pre-recorded television and the Internet. Chatrooms, e-mail, newsgroups, online discussion forums, instant messages, and consumer generated media, such as blogs, are becoming a much more common forum for communication.

WOM is spreading electronically through these forums as well. It is often difficult, however, to reliably predict how much WOM a marketing campaign or message will generate, particularly when considering electronic and other nontraditional communication forums. Some attempts have been made to forecast the impact a proposed marketing campaign may have on sales, but these techniques are often extremely difficult to implement, costly, and often yield inconsistent results.

In addition, most current campaign screening techniques only assess a marketing campaign's potential effect on sales. For example, the BASES® screening approach from VNU Marketing Information provides an evaluation of a marketing concept based on the sales potential relative to other concepts. However, this approach does not measure consumer advocacy and message amplification while predicting the likelihood of the campaign to generate WOM.

Accordingly, it is desirable to provide a marketing tool for reliably predicting the efficacy of a marketing campaign or message to generate WOM. It is also desirable to return diagnostic feedback information about a marketing message, which may be used to refine the message in order to maximize its WOM potential.

It is further desirable to provide systems and methods for identifying influential consumers and information brokers who are likely to have the greatest impact on the spread of WOM. Carefully crafted messages may be delivered to these influential consumers and impression data may be collected in order to quantify WOM and refine the marketing message to maximize its ability to generate WOM.

It is further desirable to provide heuristic systems for improving the results of current and future WOM predictions. Additionally tying these results to in-market data, such as volume, ratings, brand awareness, and sales information, is also desirable.

### SUMMARY OF THE INVENTION

These and other objects are accomplished in accordance with the principles of the present invention by providing systems and methods for measuring the efficacy of a marketing message to generate WOM. A marketer selects a target market group to market a promotional item. A marketing message is then created that meets at least one impression criterion associated with the target market group. A communication plan is developed to spread the marketing message to a subset of the target market group. Feedback data is collected from the subset, and the data is analyzed and reported back to the marketer. The feedback data may be compared to other analyses and results for marketing messages in similar product or service categories or industries.

In one embodiment of the invention, a marketing message survey is developed and delivered to a subset of the target market group. The responses to the survey may then be scored for relevance to a set of business-related WOM criteria, including purchase intent, message advocacy, and message amplification. Other message criteria may also be analyzed, quantified, and reported back to the marketer, including the estimated speed with which the marketing message travels over time, the acceleration of the message within a social network, the lifetime of the message, potential barriers to the message's adoption (e.g., geographical or cultural barriers), and how the nature of the promotional item may affect consumer adoption. These scores may be analyzed separately and reported back to the marketer, or one or more composite scores may be generated and reported back to the marketer. The marketing message may then be refined to optimize its WOM potential (i.e., its WOM score).

In another embodiment of the invention, a desired volume or equity build associated with a promotional item is received. A marketing message relating to the promotional item may be refined until the message achieves a WOM score corresponding to the desired volume build. Additionally or alternatively, a volume or equity build goal may be received, and the WOM score needed to achieve the volume or equity build goal may be calculated or derived. The volume or equity build information may be derived from in-market store and sales data, as well as past results, and reported back to the marketer.

In yet another embodiment of the invention, a computer program running on a processor is provided for predicting the efficacy of a marketing message to generate WOM. The program may include program logic to deliver a marketing survey containing a marketing message to a subset of the target market group. The program logic may receive feedback data in the form of survey responses from the subset of the target market group. The program logic may then analyze the received data and calculate at least one score reflecting the marketing message's ability to generate WOM. The program logic may then compare the score with other scores relating to marketing messages in selected categories or industries. The program logic then output the results to the user or marketer.

### BRIEF DESCRIPTION OF THE DRAWINGS

The above and other features of the present invention, its nature and various advantages will be more apparent upon consideration of the following detailed description, taken in conjunction with the accompanying drawings, and in which:

FIG. 1 is a block diagram of an illustrative communications network topology in accordance with the present invention;

FIG. 2 is block diagram of illustrative server resources in accordance with the present invention;

FIG. 3 is a display screen showing a portion of an illustrative marketing message survey in accordance with the present invention;

FIG. 4 is an illustrative display screen of WOM scoring results for a sample data source in accordance with the present invention;

FIG. 5 is an illustrative display screen showing a portion of a scoring report for a marketing message in accordance with the present invention;

FIG. 6 is an illustrative display screen showing a projected volume build correlation to WOM score for a sample promotional item category in accordance with the present invention;

FIG. 7 shows an illustrative process for developing a marketing message communication plan and testing the plan on a selected subset of a target market group in accordance with the present invention;

FIG. 8 shows an illustrative process for predicting the efficacy of a marketing message to generate WOM in accordance with the present invention; and

FIG. 9 shows an illustrative process for tying a marketing message to volume build predictions and other in-market data in accordance with the present invention.

### DETAILED DESCRIPTION OF THE INVENTION

Embodiments of the present invention relate to systems and methods for predicting the efficacy of a marketing message to generate WOM. The marketing message may be created by a manufacturer or marketer of a product or service. The message may be designed to do one or more of the following: 1) create awareness about the product or service; 2) elicit interest or curiosity about the product or service; 3) provide an incentive to repurchase or retry the product or service; or 4) generate consumer advocacy about the product or service. The product or service that the marketer desires potential consumers to become aware of, have a positive impression of, try, retry, purchase, repurchase, and/or advocate for, may sometimes be referred to herein as the promotional item.

In some of the embodiments described below, the marketer may select one or more target market groups in which to market the promotional item. The target market group is a group of potential consumers with at least one similar socio-demographic characteristic, such as, for example, age, sex, income, geographic location, or educational attainment.

As described in more detail below, particular individuals within a social network, called influencers, may be used to help predict certain characteristics of the marketing message. An influencer is a highly-connected or influential consumer (e.g., a consumer with a large number of social ties) within the target social network who is likely to share ideas with others in the target market group.

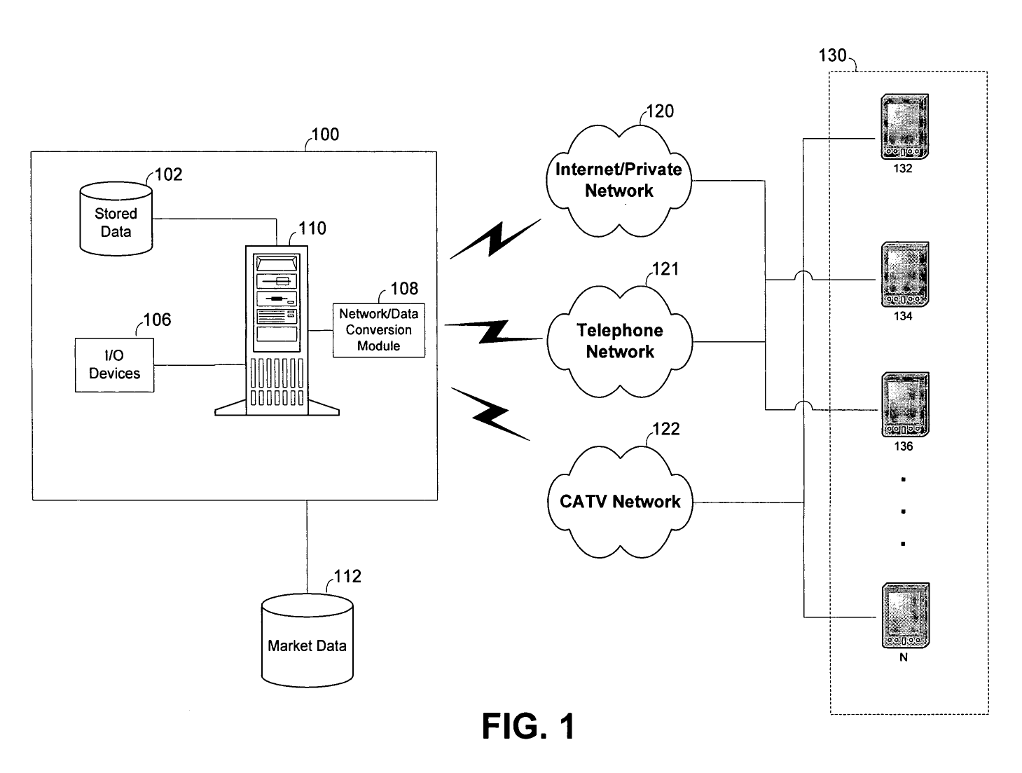

FIG. 1 shows a network diagram in accordance with one embodiment of the invention. Marketing facility 100 may include prediction server 110. In some embodiments, prediction server 110 may include processing circuitry, one or more processors, memory (e.g., RAM, ROM, or hybrid types of memory), or any other hardware or software capable of implementing a suitable program for delivering user surveys and receiving user responses over networks 120, 121, and/or 122. The program may include program logic configured to analyze the received responses, store the received responses in memory (or to an attached storage location or database), and perform any other suitable function or data manipulation on the received responses. For example, the received data may be normalized, optimized, or sorted before or after storing the responses. For added security, the program logic may also be configured to encrypt and/or decrypt the data before and after transmission or storage.

In some embodiments, prediction server 110 outputs user surveys and receives user responses in a preferred data or network format. For example, prediction server 110 may include a standard network or Web server, capable of hosting one or more webpages containing user surveys and providing various other web services over networks 120, 121, and/or 122. In this embodiment, prediction server 110 may output and receive data as TCP/IP packets. However, other data and network formats may be used in other embodiments. For example, prediction server 110 may include network/data conversion module 108 that converts raw data (or data in the preferred format) to and from another format. Network/data conversion module 108 may be implemented, for example, in hardware, software, or a combination of both hardware and software. In some embodiments, network/data conversion module 108 may include any suitable network switch or gateway that connects heterogeneous network types. For example, network/data conversion module 108 may include a SMS/MMS gateway for sending text messages over a cellular network.

For example, prediction server 110 may output user surveys as raw text (or raw XML-formatted) data read from one or more tables stored in a relational database. The raw data may then be encoded, compressed, packetized, and/or encapsulated, if required by the transmission protocol implemented on networks 120, 121, and/or 122. For example, network/data conversion module 108 may reformat and prepare text surveys to be delivered as one or more Short Messaging Service (SMS) messages or Multimedia Messaging Service (MMS) messages over cellular network 121. As another example, network/data conversion module 108 may format text surveys as one or more Instant Messages (IMs) sent over network 120.

In the depicted embodiment, network 120 comprises the Internet or a private network (e.g., an encrypted VPN tunnel). In some embodiments, data in the form of user surveys may be delivered over network 120 as standard TCP/IP packets. The surveys may be delivered to users using any suitable transmission mechanism, including email, HTTP webpages, Internet Relay Chat (IRC), or FTP. Network 120 may be a wired or wireless network. For example, network 120 may include a WiMax, Bluetooth, 802.11, or fiber-optic (e.g., SONET OC-12) network.

In the example of FIG. 1, network 121 comprises a landline telephone or cellular telephone network (e.g., a 3-G CDMA, TDM, or GSM network). In some embodiments, surveys may be delivered over network 121 using any available data or messaging service. In other embodiments, an interactive voice response (UVR) system (not shown) is implemented at marketing facility 100 to process survey requests, tally survey results, and distribute surveys to users. In these embodiments, the surveys may be delivered to users audibly over network 121, if desired. Survey responses may be entered by speaking the letter corresponding to the desired survey response choice or pressing an appropriate key or number on user telephone equipment. Brief speech responses may also be recorded digitally by marketing facility 100 and archived. The digital speech may be optionally compressed and encoded in any suitable format (e.g., MP3, WAV, WMA, MIDI formats) and stored along with the survey responses. Alternatively, in some embodiments, the IVR system may not support survey processing, but rather is used by a user to request a survey, at which time the survey may be delivered in another suitable format over networks 120, 121, and/or 122.

In the example of FIG. 1, network 122 includes a cable television (CATV) network. Surveys may be made available by any suitable multiple service operator (MSO) connected to network 122. The MSO may access various survey data sources and provide interactive surveys to users through an interactive television application or similar interface. Users may access the interactive media application through standard user television equipment, such as a DCT 2000, 2500, 5100, 6208, or 6412 set-top box (STB) provided by Motorola

In some embodiments, prediction server 110 may be connected to stored data 102 and various I/O devices 106 within marketing facility 100. Stored data 102 may include, for example, one or more databases of information (also sometimes referred to herein as data sources) containing survey questions and response choices, marketing reports, past WOM prediction results, scoring criteria, distribution lists, various models of WOM diffusion, and any other suitable marketing information. I/O devices 106 may include any suitable input, output, or finishing devices, such as a keyboard, mouse, color printer, or postproduction facility.

Marketing facility 100 may also be connected to market data 112. Although market data 112 is depicted external to marketing facility 100, market data 112 may be hosted within marketing facility 100, if desired. Alternatively or additionally, market data 112 may be provided by a third-party marketer, consultant, or data provider. Market data 112 may include, for example, promotional item sales, store, and volume information. Market data 112 may also include market share and saturation levels as well as competitor pricing and sales information. The information in market data 112 may be sorted or grouped by industry (e.g., health and beauty care), product category (e.g., hair gel), target market group (e.g., urban teenagers), location (e.g., New York City metro area), date, or any other suitable criteria.

Prediction server 110 may also include one or more network connections (e.g., Ethernet, satellite, cable, or fiber-optic connections) to networks 120, 121, and/or 122. Networks 120, 121, and/or 122 are connected to one or more user terminals or distribution groups, such as distribution group 130. Although, in the example of FIG. 1, distribution group 130 includes four users at four user communication devices (i.e., communications devices 132, 134, 136, and N), distribution group 130 may include more or less users at any suitable number of communication devices. In addition, the communication devices in distribution group 130 may be connected to one or more of networks 120, 121, and 122. For example, communication device 134 may be a PDA with cellular telephony capability. This device may be connected to both cellular network 121 and separate data network 120, such as the Internet. As another example, communication device 132 may be a television set-top box, which may be connected to both CATV network 122 and data network 120. Communications devices 132, 134, 136, and N may include computer equipment, telephone equipment, television equipment, handheld computer equipment, cellular telephone equipment, PDAs, or any other communications devices capable of connecting to at least one of networks 120, 121, and 122.

In some embodiments, communications devices 132, 134, 136, and N within distribution group 130 are not permanently connected to networks 120, 121, and/or 122. For example, distribution group 130 may include a group of 500 email users. These 500 email users may have intermittent network access (e.g., periodic Internet access when they check their email). As another example, distribution group 130 may include the members of an online chatroom, bulletin board, newsgroup, or other electronic discussion forum. In some embodiments, members of distribution group 130 may be identified by their email address, network address (e.g., IP address), username (e.g., chatroom handle or nickname), or any other suitable criterion.

Although in FIG. 1 prediction server 110 is shown internal to marketing facility 100, server 110 may be located at a third-party location external to marketing facility 100, if desired. In addition, as previously described, prediction server 110 contains program logic for delivering user surveys, processing responses, and tallying and storing survey results. Some or all of thsse functions may be implemented using one or more application processes. In some embodiments, these processes may be implemented externally or partially implemented externally to prediction server 110. For example, one or more of the processes may be at least partially implemented on a server or host computer other than prediction server 110. This server or host computer may be co-located within marketing facility 100 or located at another facility. In addition, one or more of the application processes may run using a client-server or distributed architecture where some of the application process is implemented locally on the host in the form of a client process and some of the application process is implemented at a remote location in the form of a server process. The application may also be distributed between multiple communications devices and/or servers, if desired. For example, in some embodiments, the surveys are hosted on a cluster of Web servers to reduce the workload and network latency. One or more client network sockets may be opened on each communications device in distribution group 130 to send and receive data from marketing facility 100 (or a third-party location) as needed.

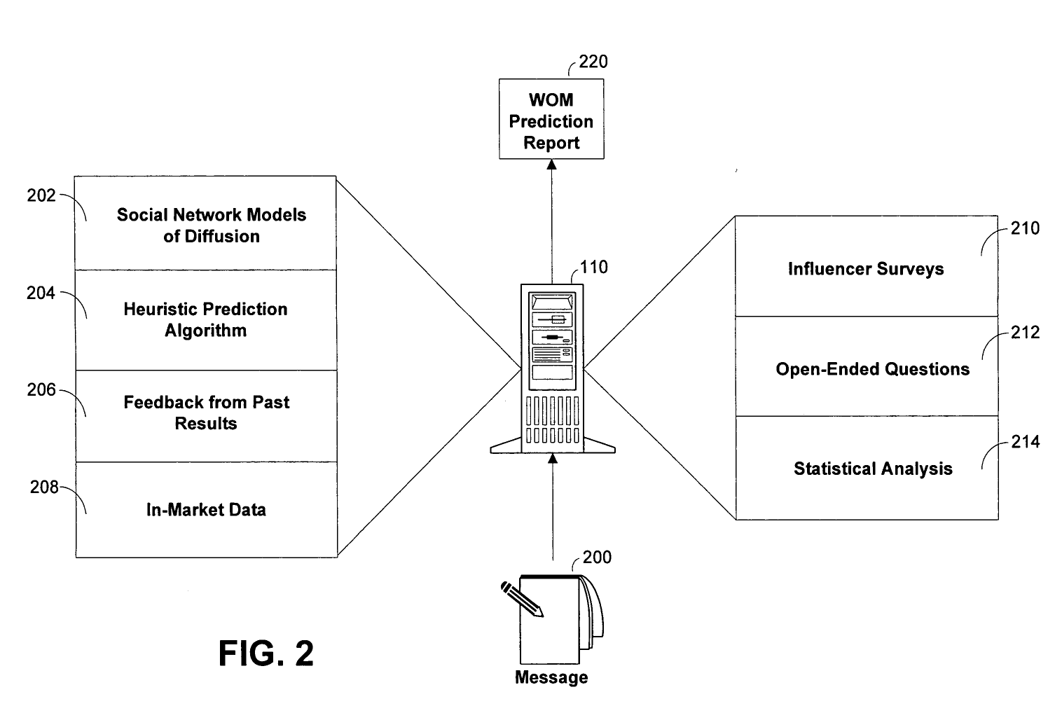

FIG. 2 shows illustrative server resources available to prediction server 110 in one embodiment of the invention. One or more marketing messages 200 may be input into prediction server 110. In a typical usage scenario, four to six different marketing messages relating to the same promotional item may be provided to prediction server 110 for analysis. Prediction server 110 may output WOM prediction report 220, which may include a numeric value, or score, for each of the key criteria responsible for generating WOM. In the described embodiment, the set of key criteria driving WOM may include purchase intent (PI), message advocacy, and message amplification. In other embodiments, however, the set of key criteria may be dynamically adjusted on-the-fly, so that new criteria may be added or existing criteria may be removed from the set of key criteria in real-time. WOM scores may then be calculated as a function of the set of chosen key criteria. Prediction server 110 may also present comparison data with other messages in a similar category, industry, or talkability range.

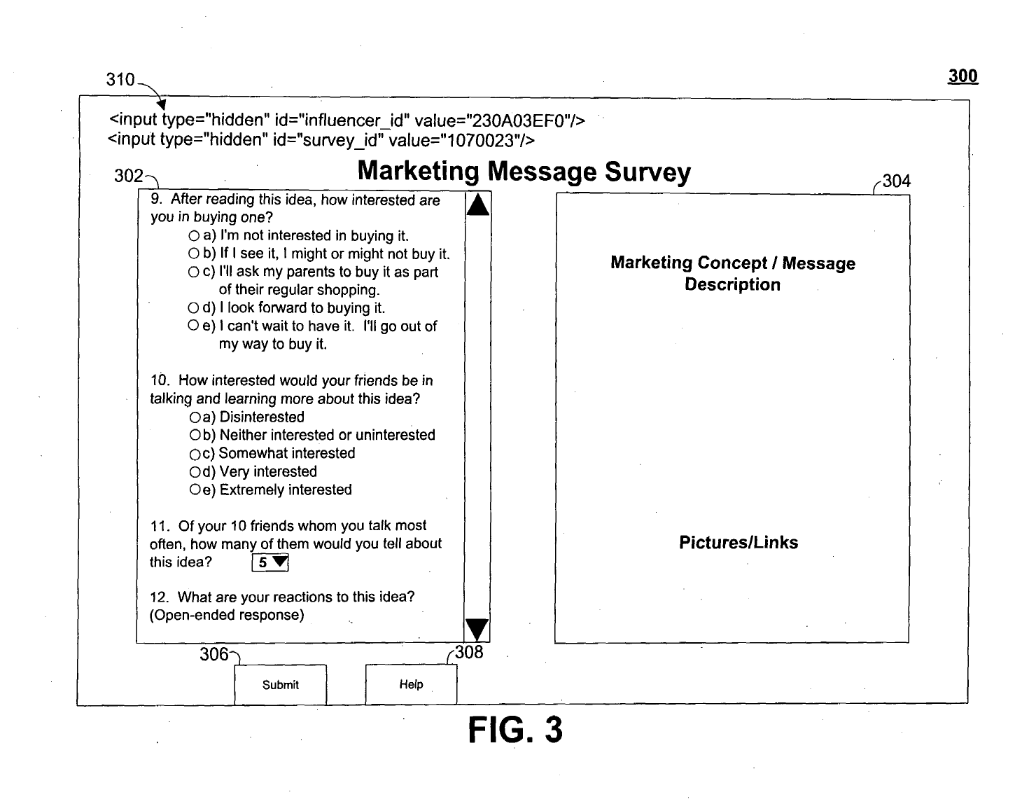

To output a prediction of the efficacy of a marketing message to generate WOM, prediction server 110 may use feedback data from influencers in the form of influencer surveys 210. An example influencer survey is depicted in FIG. 3, described below. In some embodiments, influencer surveys 210 may be electronically delivered to influencers via email or some other suitable delivery service. For example, an IM robot may be used to deliver instant message (IM) surveys to users automatically on a periodic basis. The survey may be actually embedded within the IM, or a link to a website hosting the survey may be included in the IM. As another example, surveys may be distributed via SMS/MMS to network users. In some embodiments, prediction server 110 delivers only a link to the influencer surveys to the influencers. In other embodiments, actual surveys are delivered to the influencers.

For example, influencer surveys 210 are preferably hosted as JavaScript-enabled HTML webpages by a web server running on prediction server 110. Upon following a hyperlink, influencers may access surveys using a standard web browser. However, it is to be clearly understood that any suitable delivery or hosting method may be used in other embodiments. Survey results may be indexed and stored for analysis on prediction server 110 or a coupled storage device. For example, a series of Active Server Pages (ASP), ASP.NET pages, or other similar pages may be used to store and access survey questions and results directly into and from one or more coupled databases or data sources.

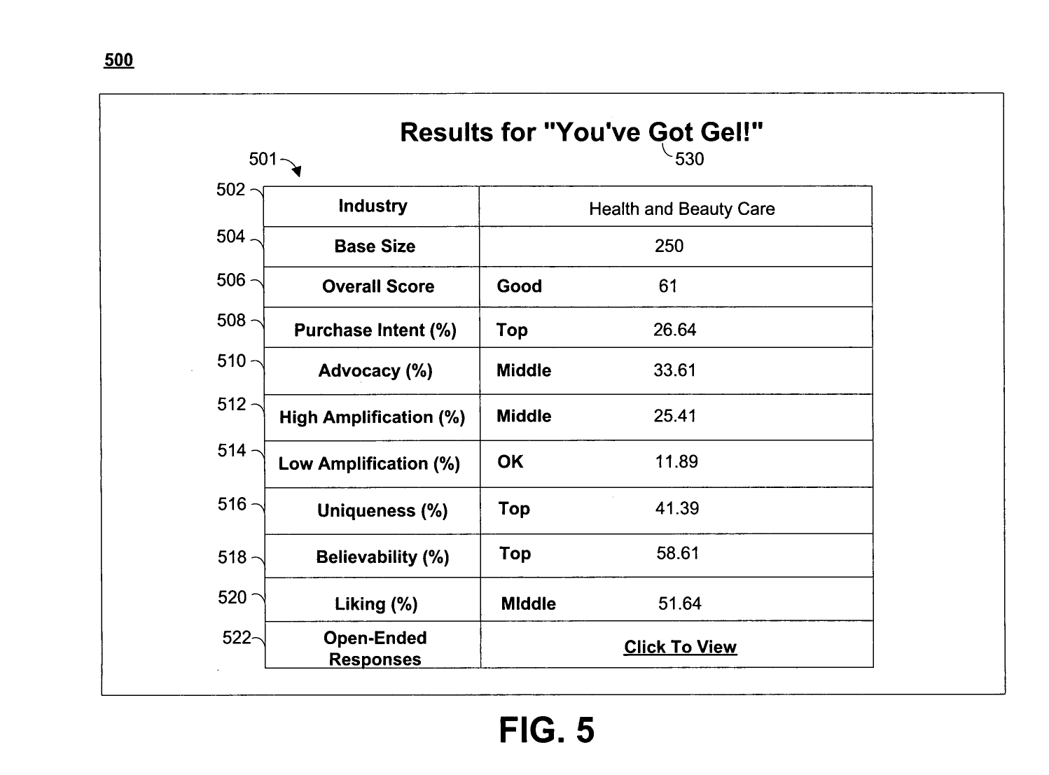

Prediction server 110 may also process open-ended questions 212. In some embodiments, open-ended questions 212 are part of influencer surveys 210. In other embodiments, open-ended questions 212 may be delivered and received separately from influencer surveys 210. Open-ended questions 212 may provide greater detail than traditional multiple choice, true/false, or range questions and may be an important part of a comprehensive WOM prediction tool. Since open-ended questions may be difficult to quantify, in some embodiments, open-ended questions are not used directly (e.g., incorporated automatically) in the WOM prediction algorithm. Rather, in these embodiments, the open-ended responses may be viewed manually for an operator or marketer to fine-tune results. For example, open-ended responses may be viewed by clicking on link 522 of FIG. 5 (discussed below).

Prediction server 110 may also use statistical analysis 214 to process influencer surveys 210. In some embodiments, the responses of each question in influencer surveys 210 (except, in some embodiments, open-ended questions 212) may be assigned a numerical or letter value. Each response may then be assigned a weight. For example, the purchase intent question “After reading this idea, how interested are you in buying the promotional item?” may have the following five response choices: “I'm not interested in buying it”; “If I see it, I may or may not buy it”; “I'll ask my parents to buy it as part of their regular shopping”; “I look forward to buying it”; and “I can't wait to have it. I'll go out of my way to buy it.”

Each one of the above five responses may be first assigned a numeric or letter identifier (e.g., the letters A through E). Then prediction server 110 may assign a weight to each response. For example, current statistical analysis may reveal that 100% of consumers who say they will go out of their way to purchase an item eventually do purchase the item, while only 50% of consumers who merely say they are looking forward to purchasing an item eventually purchase the item. Using this exemplary statistical model, prediction server may assign a value of 0.5 to answer choice D, a value of 1.0 to answer choice E, and a value of 0 to all other answer choices. The percentage of respondents with the intent to purchase the item (i.e., the message's purchase intent, or PI) may then be calculated in accordance with:

$$PI = \frac{{\sum }_{i = 1}^{N} {w}_{i}}{N} \times 100 \qquad ( EQ 1 )$$

where N is the total number of respondents to the purchase intent question and wᵢ is the weight assigned to the respondent's answer choice. The weights assigned to question response choices may take any suitable value.

The other key criteria (e.g., message advocacy and message amplification) may be calculated in a similar fashion. For example, an illustrative message advocacy question may inquire about a respondent's interest in sharing the marketing message (or the promotional item associated with the marketing message) with others (e.g., the respondent's friends). The range of responses to the illustrative message advocacy question may include “disinterested,” “neither interested nor disinterested,” “somewhat interested,” “very interested,” and “extremely interested.” Similar to the procedure described above for purchase intent, identifiers may be assigned to each response choice (e.g., the letters A through E). Using current statistical analysis 214, weights may be assigned to each response choice, and the message's advocacy percentage may be computed using an equation similar to EQ 1.

Some key criteria (including purchase intent) may be calculated from more than one question in influencer surveys 210. If more than one question is used to calculate a criterion, prediction server 110 may assign a weight to each question in the criterion calculation. Prediction server 110 may then calculate the key criterion score by computing a weighted average of all questions contributing to the criterion.

The aforementioned values selected as weights are merely exemplary. In some embodiments, prediction server 110 may adjust weights dynamically based on available market data or a change in the statistical model. As weights are updated, WOM prediction report 220 may be correspondingly updated in real-time. In some embodiments, prediction server 110 may make WOM prediction report 220 available via a standard webpage interface accessible by authorized network users. In other embodiments, WOM prediction report 220 is made available as a downloadable PDF file stored on prediction server 110.

Prediction server 110 may also access stored social network models of diffusion 202 in order to calculate one or more of the above key criteria, including message amplification. For example, the well-known Bass diffusion model, the Rogers adoptions/innovation curve, and other accepted models of social diffusion may all be accessed by prediction server 110. Using social network models of diffusion 202, prediction server 110 may take any number of suitable actions, including one or more of the following: 1) adding, removing, or altering questions and question responses from influencer surveys 210; 2) adjusting the weights assigned to responses in influencer surveys 210; 3) adjusting the weights assigned to questions included in the computation of one or more key criteria; and 4) adjusting the weights assigned to the key criteria used to calculate the overall WOM predication score. Each of the aforementioned actions may be performed prior to delivering all surveys or dynamically while surveys are live. For example, after a pre-determined number of responses are received, the survey questions and/or response choices for the questions may be changed. Changing survey questions or response choices based on a partial response set may yield more specific or targeted results.

For example, a survey question may have the following three response choices: “I hate this idea,” “I like this idea,” and “I love this idea.” If none of the first 500 user responses to the question are “I hate this idea,” then the response choices may be dynamically refined. Using this example, the “I hate this idea” response choice may be replaced with “I like this idea a lot” response choice. In this way, surveys may obtain more accurate results using the same number of response choices. As another example, weights assigned to response choices may also be dynamically adjusted while a survey if live, if desired.

In some embodiments, to calculate message amplification, social network models of diffusion 202 may provide the ideal weights to assign to each response to the one or more amplification questions included in influencer surveys 210. The weights derived from social network models of diffusion 202 may provide increased accuracy and more reliable results.

In some embodiments, prediction server 110 may also use heuristic prediction algorithm 204 that may use feedback from past prediction results 206. For example, key criteria scores, including purchase intent, message advocacy, and message amplification, may be presented in comparison to other recent prediction results of marketing messages in similar categories, industries, or talkability ranges. For example, a marketing message for a new hair gel may be compared only against other products in the hair gel category (or the health and beauty care industry). Alternatively or additionally, WOM prediction results may be compared only to results computed within a user-specified time range. For example, in some embodiments, prediction results older than six months may be excluded from the criteria score calculation. In another embodiment, all the results in a given category or industry are used in the prediction results, but more recent results are given more weight than older results. In these embodiments a moving average may be used give more recent results greater weight.

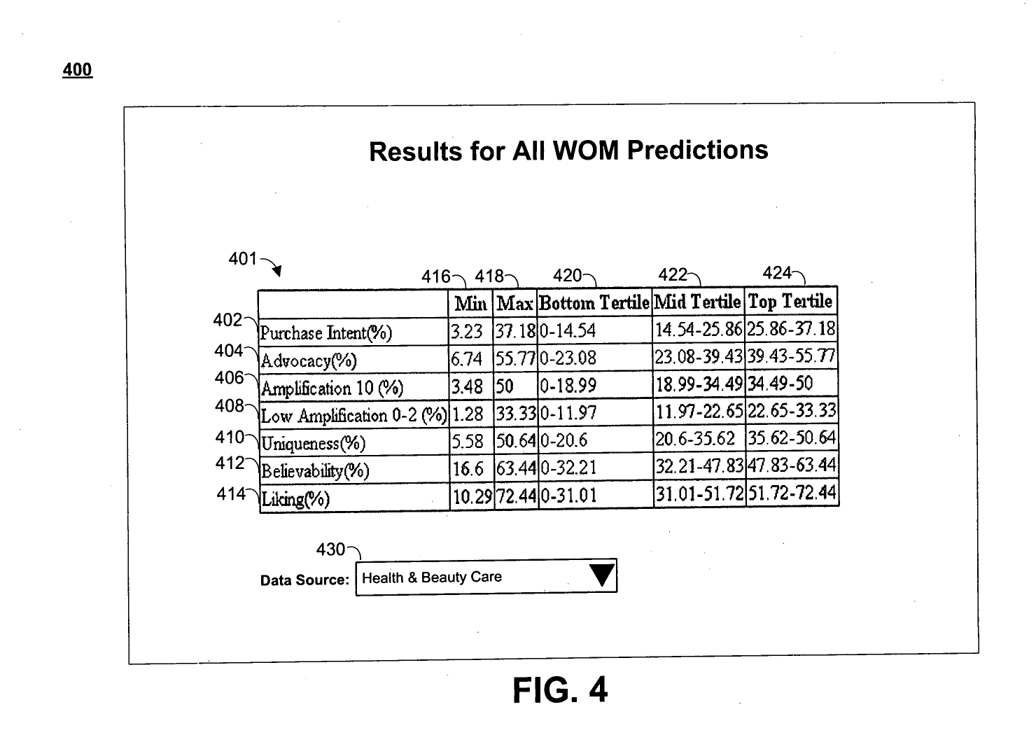

As described in more detail below with regard to FIGS. 4 and 5, the range of result comparisons may significantly affect the WOM prediction report. Accordingly, feedback from past prediction results and post-prediction data obtained from an analysis of in-market data 208 may put the three key criteria scores in perspective to other marketing messages with known results.

FIG. 3 shows illustrative display screen 300 containing survey area 302, marketing message area 304, and buttons 306 and 308. As depicted in the example of FIG. 3, the marketing message may be described in message area 304 to the right of survey area 302. In addition to describing or presenting the marketing message, the promotional item may also be described and/or depicted in message area 304. Pictures of the promotional item, technical descriptions, and links to more information may also be provided to the user in message area 304, if desired.

In survey area 302, the questions of the influencer survey may be displayed to the user. In some embodiments, all survey questions are presented in a single page. For example a text area with vertical scroll bars may be used to display the survey questions. The user may scroll up or down in survey area 302 to view the entire survey. In other embodiments, a series of linked pages are used to display all the questions of the survey. A single question may be included on each linked page, or several questions may be included on a single page.

In some embodiments, the survey questions in survey area 302 may be divided into four types: screening questions, key criteria questions, diagnostic questions, and optional stage questions. One or more screening question may be included in survey area 302 to screen potential respondents and identify key influencers. For example, screening questions may relate to the potential respondent's frequency of usage or preferred brand(s). An example screening question included in an influencer survey relating to a new hair gel might include “What brand of hair gel do you use most often?” or “How many times a week do you use hair gel?”

The second type of question in survey area 302 may include key criteria questions. As mentioned above, a marketing message's ability to generate WOM may be a function of three key criteria: purchase intent, message advocacy, and message amplification. These three key criteria may represent the largest factors influencing the efficacy of a marketing message to generate positive WOM. In addition, these three key criteria are largely statistically uncorrelated with one another, resulting in less skewed results and better differentiation among messages with similar survey responses. As described above, the purchase intent, message advocacy, and message amplification associated with a marketing message may be quantified by prediction server 110 (FIG. 1) from one or more questions in the influencer surveys. Although the exact phrasing (and number) of the key criteria questions may vary as described above, illustrative questions are presented below.

Purchase Intent: the question or questions related to purchase intent may help identify enthusiasts and measure the likelihood of the influencer to purchase, repurchase, try, or retry the promotional item. The purchase intent score may quantify the number of consumers willing to purchase the promotional item based on the marketing message. For example, one question used to calculate purchase intent may include: “After reading about this idea, how interested are you in buying/trying it?”

Message Advocacy: the question or questions related to message advocacy may help measure the likelihood of an influencer to be a broker (i.e., advocator) for the promotional item. The message advocacy score may quantify the ability of the marketing message to spread positive WOM about the promotional item. For example, one question used to calculate message advocacy may include: “How interested would your friends be in talking and learning more about this idea?”

Message Amplification: the question or questions related to message amplification may help measure the potential WOM spread of the message. Message amplification may be directly proportional to the message's ease of diffusion through the influencer's social network due to the message's reduced personal risk. The message amplification score may quantify the projected WOM reach of the marketing message. For example, one question used to calculate message amplification may include: “Of your 10 friends whom you talk with most often, how many of them would you tell about this idea?”

The above survey questions and key criteria are merely illustrative. Other survey questions and key criteria may also be used to quantify the driving factors behind the generation and spread of WOM.

Diagnostic questions may also be included in survey area 302. Diagnostic questions may provide valuable feedback on refining or improving the marketing message. In some embodiments, several categories of diagnostic questions may be included in the influencer surveys, including questions related to innovation or uniqueness, consumer liking, and believability. In some embodiments, these diagnostics questions may be presented after the key criteria questions; however, any arrangement of questions may be used, including alternating key criteria and diagnostic questions within the same survey.

For example, a diagnostic question relating to message liking may include: “Overall, how well do you like this idea?” Response choices ranging from “don't like it” to “love it” may be presented to the respondent. The prediction server may process all the diagnostic question responses and derive one or more diagnostic scores for the marketing message. These scores may then be used to refine the message in an effort to increase or optimize its scores.

Optional stage questions may also be included in survey area 302. As described in more detail below, surveys may be distributed to influencers at various times, or stages, during the marketing message's development process. The surveys may be distributed to a different group of influencers at each stage. In addition, stage specific questions may be added to the influencer surveys in some embodiments. In the first stage, one or more stage questions relating to the marketing concept may be included in survey area 302. For example, a question inquiring about the effectiveness of the marketing concept to communicate the desired brand equities may be included in the survey during the first stage of surveys.

During the second stage, one or more questions relating to potential amplification tools may be included in the survey. For example, message amplification tools may include free samples of the promotional item, stickers, postcards, games, wristbands, or any other tool designed to amplify WOM and spark conversation about the promotional item. The stage questions included in surveys in the second stage may ask, for example, how likely influencers would be to share certain amplification tools with their friends. The third stage may include a final quality control survey distribution. This final survey distribution may be used as a verification that market factors and social trends have not changed significantly since the first survey distribution. Although three stages of survey distributions may be used in some embodiments, the precise number of stages and survey distributions may be selected by the marketer. For example, for less expensive campaigns, less stages may be used to reduce program costs.

The aforementioned questions may be framed as open-ended, multiple choice, range, true/false, or any other type of question. For example, a diagnostic question relating to message or promotional item believability may have a response range from “completely unbelievable” to “completely believable.” Radio buttons, text boxes, text fields, drop-down choice lists, or any other input widget may be used to receive the survey question responses. In addition, the response choices may be reversed or reordered among survey questions within the same survey in order to mitigate the effect of random guessing or the “straight-line” selection of survey answers.

Although in the depicted embodiment surveys are delivered to influencers electronically via a webpage or similar interface, surveys may also be delivered to influencers by more traditional means, including postal mail. Once the surveys are completed and returned (perhaps via prepaid return postal mail), survey answers may be manually entered or scanned and electronically captured (e.g., via OCR or some other response recognition technique). Although processing of survey answer responses may be more difficult if the surveys are not submitted electronically, standardized bubble test forms may be used in some embodiments to increase processing efficiency.

If electronic surveys are used, in some embodiments, influencers may be provided with an email notification when a new survey is available. Influencers may access a new survey via a hyperlink embedded in the email notification message. Additionally or alternatively, influencers may login to a service or website that hosts the surveys. Once logged in, a user may view all available uncompleted surveys, view all completed surveys, save a partially-completed survey for later completion, update the user's profile, chat with other members of the survey group, or perform any related function.

Prediction server 110 (FIG. 1) may assign one or more unique identification numbers 310 to the survey or the influencer. In the example of FIG. 3, the survey includes one or more identification numbers 310 as hidden fields in the survey webpage. In some embodiments, these identification numbers may include an identification number that uniquely identifies the particular influencer taking the survey. This identifier may be saved along with survey answers to permit an influencer to save survey results and begin at the point where the survey was last saved. Surveys may be saved to prediction server 110 (FIG. 1), at marketing facility 100 (FIG. 1), or on each influencer's individual terminal. If the survey results are saved at an insecure location, the survey results may be encrypted before saving. In some embodiments, the influencer's unique identifier is used as a cryptographic key to access and encrypt/decrypt the influencer's survey results.

In some embodiments, several other unique identifiers are also associated with the current survey or the influencer taking the survey. For example, a unique survey identifier may be used to uniquely identify the survey questions and answer choices. For example, a survey relating to a single marketing message may have several different versions. In some versions, questions and/or answer choices may be reordered or refined as described above. In these embodiments, each version of the survey may be assigned a different survey identification number, which may be used by the prediction survey in tallying survey results.

To submit survey answers to the prediction server, the influencer may select submit button 306. In some embodiments, upon selecting submit button 306, the influencer is presented with one or more additional pages of survey questions. In these embodiments, survey answers may be submitted to the prediction server incrementally, one page at a time. Alternatively, survey answers could be cached on the local user terminal and submitted in bulk after a certain number of surveys have been completed. This may help save bandwidth in bandwidth-limited environments. Upon selecting submit button 306, the survey responses may be saved to a database, hard disk, or other storage device accessible by prediction server 110 (FIG. 1).

To bring up a page, frame, or window with help information, the influencer may select help button 308. Upon selecting help button 308 the influencer may be presented with frequently asked questions (FAQs), survey instructions, or any other suitable information.

After prediction server 110 (FIG. 1) receives survey results from a requisite number (e.g., a user-selected base size) of influencers, the server may compute WOM scoring results and present these results to the marketer. In some embodiments, results for a marketing message may be recalculated after each survey submission for a particular survey and marketing message. In other embodiments, results may be recalculated only after a system-specified number of survey submissions. For example, after 10 influencers submit their survey responses for a particular marketing message to prediction server 110 (FIG. 1), the server may update the corresponding marketing message's WOM scores.

FIG. 4 shows an illustrative page of WOM scoring results. Display screen 400 may include table 401 and data source selector 430. In some embodiments, the results in table 401 may reflect the results of all marketing messages in the current database or data source. Table 401 may also be adjusted to reflect the results in a particular industry or product category. For example, by adjusting data source selector 430, table 401 may be automatically updated to reflect the results of surveys in the selected data source. In the example of FIG. 4, table 401 includes results relating to promotional items in the health and beauty care industry.

Table 401 may display results in a number of ways. For example, the three key criteria (purchase intent, message advocacy, and message amplification) may be listed at the top of the table as rows 402, 404, and 406, respectively. In some embodiments, row 406 represents the percentage of influencers who answered the question or questions relating to message amplification with the highest answer choice (e.g., sharing with 10 out of their 10 closest friends). Row 408 may reflect the percentage of influencers that selected the lowest answer choices for the amplification question or questions (e.g., sharing with 0-2 out of their 10 closest friends) for a particular marketing message. Rows 410, 412, and 414 may list the percentage of affirmative responses to the diagnostic questions relating to message or promotional item uniqueness, believability, and liking, respectively.

The rows in table 401 are merely illustrative. Rows may be added or removed without departing from the spirit of the invention. One or more new message amplification rows may be provided to give more information to the marketer. For example, a new row may be inserted into table 401 corresponding to the percentage of respondents who answered they would share the marketing message with 5-9 out of their 10 closest friends (from the message amplification question in the survey). This may result in row entries reflecting the percentage of respondents answering with high message amplification (e.g., row 406), low message amplification (e.g., row 408), and medium message amplification (e.g., the new row).

Each of rows 402 through 414 may be associated with data columns for the minimum percentage of affirmative survey responses and the maximum percentage of affirmative survey responses for all marketing messages in the data source selected in data source selector 430. In the example of FIG. 4, the percentage of respondents with the intent to purchase a promotional item associated with a marketing message in the health and beauty care industry ranged from a low of 3.23% to a high of 37.18%. As described above, purchase intent may be derived from one or more survey questions relating to purchase intent. This is reflected in minimum column 416 and maximum column 418. Each of rows 402 through 414 may also include breakdowns for the bottom tertile range (i.e., results for the lowest third of messages), middle tertile range (i.e., results for the middle third of messages), and top tertile range (i.e., results for the highest third of messages). These values may be listed in columns 420, 422, and 424, respectively.

Results for a particular marketing message may be displayed in report form, as shown in illustrative display 500 of FIG. 5. In some embodiments, display 500 may be an electronic display, such as a webpage or electronic document (e.g., a Microsoft® Word or PDF document). The name or identification number of the marketing message may be displayed in title area 530. Title area 530 may also include the generation date of the report data listed in table 501. In row 502, the industry or product category associated with message may be displayed. Below the industry, in row 504, the base size (e.g., the number of actual or anticipated respondents) may be displayed. The value in row 504 may be updated as new respondents submit survey responses (and after those responses are reflected in the results in table 501). In row 506, the message's overall score may be displayed. In some embodiments, messages may be given overall scores of excellent, very good, good, fair, and poor. An excellent score may be assigned to messages performing in the top tertile for all three key criteria. A very good score may be assigned to messages performing in the top tertile on two of the three key criteria, yet no criteria in the bottom tertile. A good score may be assigned to messages performing in the top tertile on one of the three key criteria, yet no criteria in the bottom tertile. A fair score may be assigned to messages with a bottom tertile score on one key criteria. Finally, a poor score may be assigned to messages performing in the bottom tertile on two or more key criteria. In other embodiments, a numeric overall score may be displayed to quantify the above criteria. For example, a 0-90 scoring scale may be used for a message's overall score where messages are given 30 points for each key criteria in the top tertile. Ten points may be given for the middle tertile and zero points for the bottom tertile. Other overall scores (including a star rating system) may be used in other embodiments.

The message's purchase intent score may be displayed in row 508. This score may be computed using EQ. 1. Next to the numeric purchase intent score in row 508, the purchase intent tertile (top, middle, or bottom) of all the messages in the same product category or industry may be displayed. Similarly, the message's advocacy score may be displayed in row 510, and the message's high amplification score may be displayed in row 512. As described above, in some embodiments high amplification may be calculated from the number of influencers selecting the highest answer choice on the message amplification question. Other algorithms may also be used. For example, high amplification may be considered the top two answer choices on the message amplification question. The algorithm may also be dynamically refined based on an analysis of in-market and post-program data. Similarly, the message's score for low amplification may be displayed in row 514. In some embodiments, low amplification is calculated from the number of survey respondents selecting the bottom two answer choices for the message amplification survey question; however, low amplification may be calculated in other ways (e.g., using the number of respondents selecting the bottom three answer choices).

Below the results for the key criteria, the results relating to the diagnostic questions may be displayed. Results table 501 may include row 516, which may display the message's uniqueness score. In row 518, the message's believability score may be displayed, and in row 520 the message's liking score may be displayed. Similar to the results for the key criteria, the diagnostic scores of uniqueness, believability, and liking may be derived from survey responses to influencer surveys, like the survey in display screen 300 (FIG. 3). In addition to displaying the percentage score, the tertile the score falls in (among all the messages in the same product category or industry) may also be displayed to the marketer.

If the survey included open-ended response questions, like questions relating to an influencer's personal reaction to the message or the promotional item associated with the message, the open-ended responses may be displayed by clicking on link 522. Upon selecting link 522, a new window, frame, or panel may be presented to the user listing the verbatim responses submitted by the survey respondents. In some embodiments, open-ended responses may be automatically parsed for certain keywords to help classify the answer as positive, negative, or neutral. For example, responses containing the words “great,” “awesome,” or “terrific” (or other similar words) may be classified as positive responses. These open-ended responses may then be grouped for ease of navigation. Additionally, in some embodiments, vulgar or profane words and phrases may be removed from open-ended responses and replaced with suitable substitutes, if desired.

In some embodiments, display 500 may include a side-by-side comparison of at least one other marketing message's results. For example, display 500 may be divided into three columns where each column includes a table similar to table 501. The tables may correspond to results data for other marketing messages in a similar product category, industry, product price range, or any other suitable characteristic. The results may then be compared to one another in a single display screen, if desired.

The results shown in FIG. 5 may also be grouped or sorted by any suitable criteria. In some embodiments, table 501 may include scores and percentages derived from all received responses. A user may then select to restrict (or recalculate) results for responses received from respondents matching a certain socio-demographic criterion or criteria. In this way, responses only from respondents in a certain age or income range may be filtered and displayed in table 501. For example, to provide a detailed analysis only for a particular age group, a user may select to filter the results in table 501 into five age groups, 20-29, 30-39, 40-49, 50-59, and 60-69 years of age. The results may then be recalculated for each age group so that comparisons may be drawn between the age groups. In some embodiments, the age groups are predefined by the prediction server. In other embodiments, the age groups may be specified by the user. Similar comparisons may be viewed for other socio-demographic factors, such as income, location, education, race, etc. In this way, a more comprehensive picture of the marketing message's ability to generate WOM among and between certain subsets of a social group may be provided.

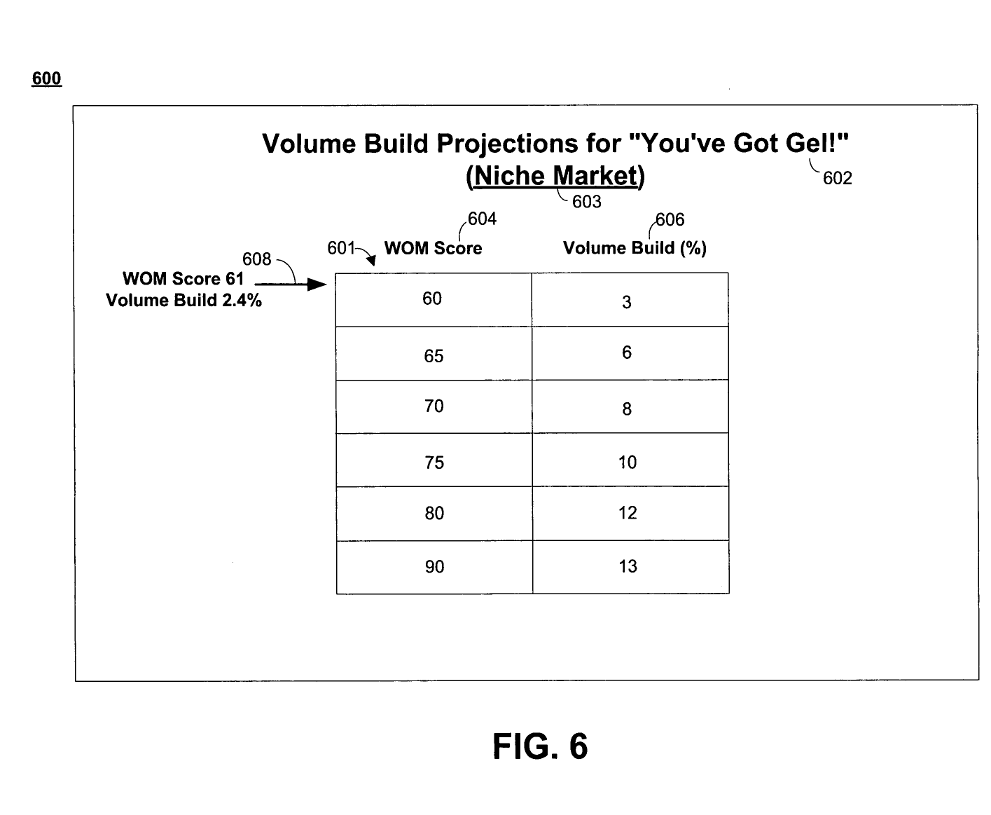

FIG. 6 shows an illustrative display screen showing the projected correlation between overall message WOM score and volume build of the promotional item. The name of the marketing message may be displayed in title area 602. Table 601 may list a range of WOM scores next to the projected volume build associated with the scores. The range of WOM scores in column 604 may be selected by the marketer in some embodiments. In other embodiments, the prediction server automatically selects the range for WOM score column 604 based on the results of the current marketing message. For example, the prediction server may display table 601 with a WOM score range from 60 to 90 for a message that receives an overall score of 61. This allows the marketer to see the projected volume build corresponding to the message's current WOM score as well as the volume builds for enhanced WOM scores. In this way, the marketer may decide if the marketing message should be refined in an effort to increase the message's WOM score (and hence projected volume build).

The projected volume builds listed in column 606 may be derived, at least in part, from previous WOM predictions performed by the prediction server that were actually implemented. Since the prediction server is connected to in-market data (such as gross sales and volume information), the prediction server may store actual volume builds for previously implemented messages. The prediction server may then associate these actual volume builds with the corresponding WOM prediction scores. From this data, the prediction server may build a list of WOM scores/volume build data points. From these data points, the prediction server may derive a volume build function using any available technique. For example, a linear or non-linear regression (using, for example, linear or non-linear least squares regression) may be performed to create a volume build model. This model may be saved to the prediction server and updated as new data (e.g., volume builds and/or WOM scores) becomes available.

The prediction sever may also access other information to fine-tune volume or equity build predictions. For example, attitudinal measurements related to consumer behavior may be used to tweak projections. In some embodiments, the type of market may also be used to help compute projected volume builds. For example, a certain WOM score in a specialized, niche market may not have the same effect as the same WOM score in a larger, more general market. The market type may be converted to a scaler (e.g., multiplier) and used by the prediction server to fine-tune equity or volume build results. In some embodiments, the market type for the current marketing message may be displayed as market type indicator 603. In the example of FIG. 6, market type indicator 603 informs the marketer that the volume or equity build projections displayed in table 601 are suitable for promotional items in niche markets. The market type associated with the current marketing message may be toggled to another market type by clicking on indicator 603. Upon clicking on indicator 603, the volume or equity build information may be refreshed in real-time. In this way, the user may be presented with the projected volume or equity build associated with a particular WOM score across more than one market type.

In some embodiments, the marketing message's current WOM score and volume build may be indicated by arrow 608. Arrow 608 may show the marketing message's current score in table 601. Next to arrow 608, the actual numeric WOM score of the marketing message may be displayed, along with the projected volume build. In some embodiments, a user may slide or drag arrow 608 (e.g., in a Java applet or other suitable interface) up or down along the left side of table 601 in order to be presented with new WOM score/projected volume build pairs.

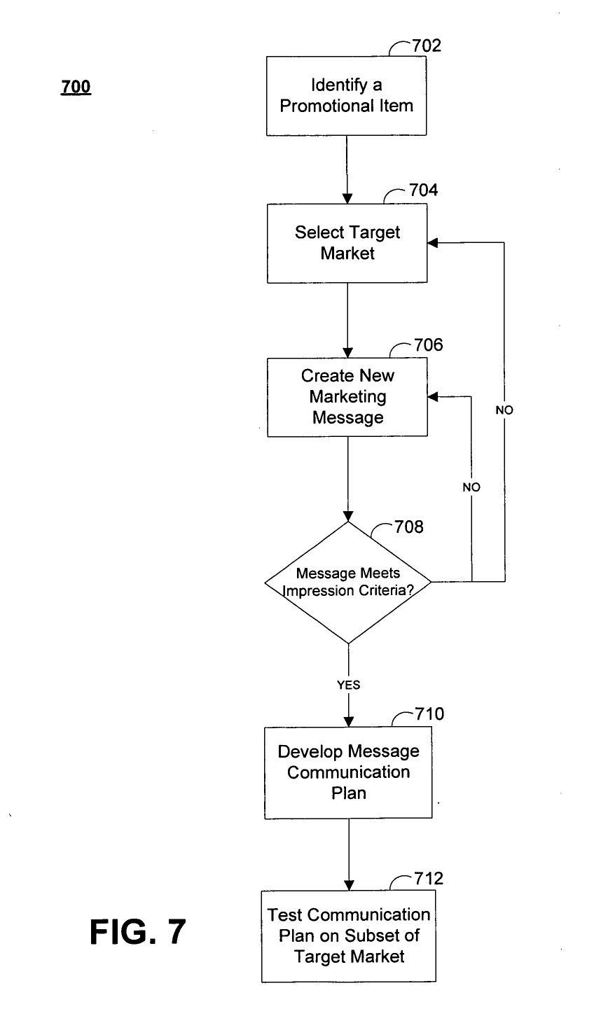

FIG. 7 shows illustrative process 700 for developing a marketing message communication plan. At step 702, a promotional item may be identified by the marketer. At step 704, the target market for the promotional item may be selected. For example, a new hair gel may be identified as the promotional item at step 702, and the target market may be urban teenagers. At step 706, a new marketing message is developed. The marketing message may be carefully designed to resonate with, or otherwise have some positive influence upon, the target market selected in step 704.

In other words, the message may meet one or more impression criteria associated with the selected target market. In some embodiments, the impression criteria may be selected from the same key or diagnostic criteria used to predict WOM (e.g., message advocacy, likeability, and uniqueness). In other embodiments, the message is additionally or alternatively rated on such factors as social appeal, simplicity, and ease of integration into conversation among the target market group. Based on these factors, the message may be assigned an impression index which predicts how well the message will resonate with the target market group.

For example, the marketing message “You've got gel” may be created for a new hair gel product designed to resonate with urban teenagers. This message may score well in the simplicity and ease of integration into conversation categories, but low in the uniqueness category. The results of other marketing messages in similar product categories or industries may also be consulted in order to calculate a composite impression index for the message. At decision 708, the new message's impression index may be compared to a threshold impression index. If the message's impression index does not meet the threshold impression index, a new message may be generated at step 706 or a new target market may be selected at step 704. Otherwise, a message communication plan may be developed at step 710.

In order to develop a message communication plan at step 710, one or more surveys may be generated. These surveys, like the survey displayed in display screen 300 (FIG. 3), may include one or more questions directed to the set of key criteria that drive the spread of WOM: purchase intent, message advocacy, and message amplification. Key criteria may be added and removed from the set dynamically, as described above. In addition, a number of diagnostic and screening questions may also be included in the survey. As part of the communication plan developed at step 710, surveys may be distributed one or more times, depending on such factors as, for example, the promotional item, the number of marketing messages, the cost, and the accuracy of the WOM prediction desired.

For example, a marketer who wants a highly reliable WOM prediction may opt to distribute surveys three times to large base sizes. Other communication plans may include more or less survey distributions. In addition to the number of survey distributions, the method of distribution may also be defined at step 710. For example, surveys may be delivered electronically via a web interface, via email, or via traditional postal mail.

Once a communication plan is developed at step 710, the plan may be tested on a subset of the target market selected in step 704. For example, the surveys developed as part the communication plan may be distributed to a distribution group, such as distribution group 130 (FIG. 1). This distribution group may include one or more influencers in the target market group.

In practice, one or more steps shown in process 700 may be combined with other steps, performed in any suitable order, performed in parallel—e.g., simultaneously or substantially simultaneously—or removed. For example, decision 708 may be eliminated if the message created at step 706 already meets the impression criteria threshold for the target market group selected at step 704.

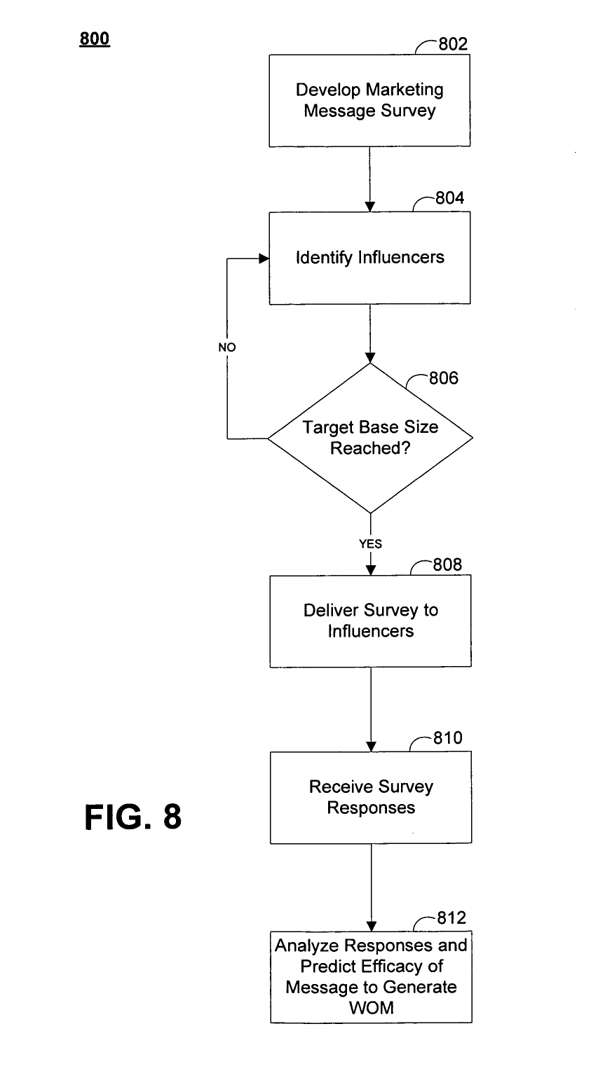

Steps 710 and 712 of FIG. 7 are shown in more detail in FIG. 8. Illustrative process 800 starts with the development of a marketing message survey at step 802. Surveys may be developed automatically using stored survey questions and response choices or surveys may be input manually at step 802. Typically, however, surveys may be developed from a set of base questions and then manually refined or tailored to the specific promotional item. For example, the available response choices for a question relating to a frequency of use question for a hair gel may be different than the available response choices for a frequency of use question relating to a chewing gum. As another example, after the base survey is generated specific references to the promotional item may be added to give the survey a less generic feel.

Since, in some embodiments, the efficacy of a marketing message to generate positive WOM is presumed to be a function of the message's purchase intent, message advocacy, and message amplification, at least one question included in the survey may relate to each of these three key criteria. In some embodiments, more than one question is used for each key criteria. As described above, the key criteria may be altered at any time. In addition, the weights assigned to each criteria may be adjusted dynamically while a survey is live. For example, three questions relating to purchase intent may be included in the survey. Accordingly, the responses for all three questions may be incorporated into the purchase intent score for the message. As described in regard to FIG. 2, the weights assigned to each of these three questions in the total purchase intent score may be unequal, if desired.

At step 804, a subset of the target market group may be identified for survey distribution. This subset may include influencers in the target market group. More influencers may be added to the subset until, at decision 806, it is determined that the target base size for the message is reached. The target base size may be established by the system or by the marketer. Although increasing the base size may improve results, statistical analysis may show that once a threshold target base is reached any improvement in results may be negligible. The base size may be adjusted from message to message, depending on the cost the marketer is willing to spend on the program, the overall size of the target market group, and the reliability of past results in the chosen market or industry.

Once the target base size is reached, the survey may be delivered to the distribution group at step 808. In some embodiments, surveys may not be actually delivered to influencers in the distribution group. Rather, a notification that a new survey is available may be communicated to each influencer in the distribution group. For example, an email message may be sent to the influencers in the group. The email may include a link to participate in the survey. In order to promote participation, in some embodiments, incentives may be given to influencers who complete a survey (e.g., free samples, sweepstakes entries, etc.). The prediction server may then collect the survey responses at step 810. As shown in FIG. 3, in some embodiments, responses are sent to prediction sever 110 (FIG. 1) after an influencer presses submit button 306.

At step 812, the prediction sever may analyze the received responses and generate a predication as to the message's efficacy to generate WOM. As described above, this prediction may take the form of a composite score derived from the percentage of survey responses relating to three key criteria: influencer purchase intent, message advocacy, and message amplification. A scoring system may be implemented that translates these raw percentage scores into a more user-friendly overall WOM score of excellent, very good, good, fair, and poor. In addition, diagnostic scores related to believability, liking, and uniqueness may be calculated from the received survey results. These scores may be used to help refine the marketing message and maximize the message's WOM potential.

In practice, one or more steps shown in process 800 may be combined with other steps, performed in any suitable order, performed in parallel—e.g., simultaneously or substantially simultaneously—or removed. For example, step 812 of analyzing the survey responses may be performed simultaneously with step 810 in some embodiments. As survey responses are received, the responses may be incorporated into the WOM prediction results so that the WOM scores are always current.

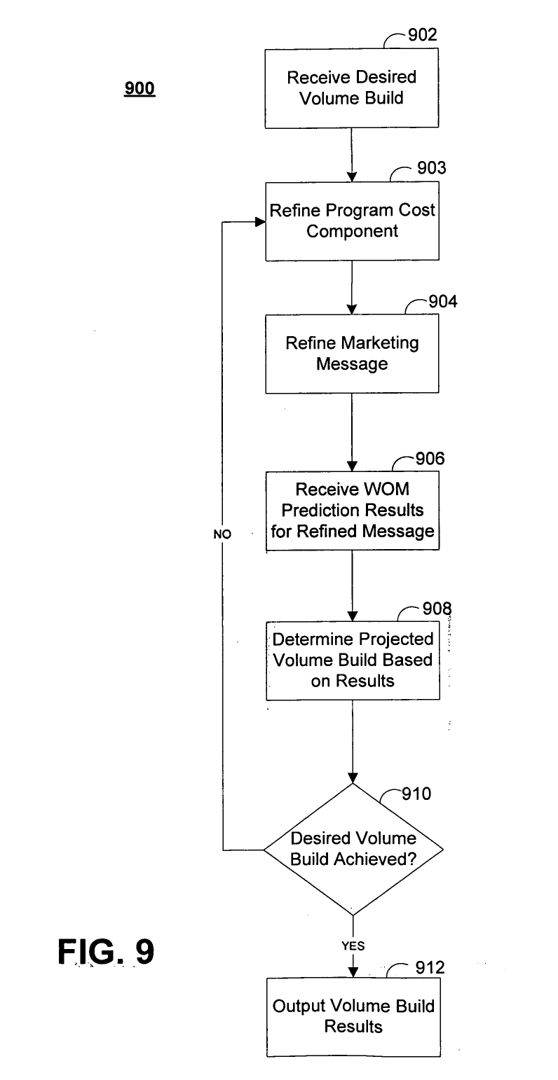

FIG. 9 shows illustrative process 900 for refining a marketing message until a desired promotional item volume build is achieved. At step 902, a desired volume build may be received by the prediction server. At step 903, a program cost component relating to the WOM prediction program may be refined. For example, in some embodiments, the marketer may adjust the number of influencers used in the program. The effect of including additional influencers may be incorporated into the WOM prediction results. The additional program cost for including the new number of influencers may also be displayed to the marketer at step 903. The effect of including more or less influencers on the marketing message's WOM score, volume build, or equity build may also be projected and presented to the marketer. At step 904, the marketing message may be refined. For example, scores from diagnostic questions may be used as feedback in an effort to improve the message's WOM prediction results. At step 906, the refined message's WOM prediction score may be calculated. Using this score, the prediction server may project a volume build associated with the WOM prediction results at stage 908. In order to project a more accurate volume build, the prediction server may access stored data, such as in-market data 112 of FIG. 1. This data may include store sales and volume data as well as previous WOM prediction results for other messages in a similar category or industry.

If, at decision 910, the prediction server determines that the desired volume build is achieved with the message's WOM prediction score, the volume build results may be presented to the user at step 912. For example, table 601 with arrow 608 (FIG. 6) may be displayed to the user. Otherwise, the message may be refined in order to increase its WOM prediction score (and corresponding volume build).

Linking WOM prediction results to volume and other in-market results enables the prediction server to project the marketing message's economic benefit to the marketer. With this information, the prediction server may generate and display scenario predictions to the user. For example, using linear or non-linear regression of in-market data and past WOM prediction results, the prediction server may derive one or more models of volume build. The prediction server may then plot projected volume build against WOM prediction score for each data source, industry, or product category. For example, an overall WOM prediction score of 70 may correspond to a projected volume build of 10% in the health and beauty care industry, while the same score in the food and beverages industry may correspond to a projected volume build of 15%. With this information, the marketer may be presented with the required WOM score to result in a desired projected volume build. The marketer may also be presented with other information, such as the gross sales and profit information associated with the volume build.

In practice, one or more steps shown in process 900 may be combined with other steps, performed in any suitable order, performed in parallel—e.g., simultaneously or substantially simultaneously—or removed.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for predicting the efficacy of a marketing campaign, the method comprising:
identifying a promotional item;
selecting a target market group to market the promotional item;
creating at least one marketing message corresponding to the promotional item, wherein the marketing message meets an impression criteria associated with the target market group;
developing a communication plan to communicate the at least one marketing message to a subset of the target market group, wherein the communication plan comprises at least one survey with at least one question relating to the marketing message;
testing the communication plan with the subset of the target market group;
receiving results from the testing of the communication plan from the subset of the target market group; and
analyzing the results received from the testing, wherein analyzing the results comprises calculating at least one score for the marketing message, the at least one score derived at least in part from responses to the at least one survey.

2. The method of claim 1 wherein testing the communication plan comprises delivering the at least one survey to the subset of the target market group.

3. The method of claim 2 wherein delivering the at least one survey to the subset of the target market group comprises delivering at least one electronic message to the subset of the target market group, the electronic message selected from the group consisting of an email message, a text message, an Instant Message (IM), a Short Messaging Service (SMS) message, and a Multimedia Messaging Service (MMS) message.

4. The method of claim 2 delivering the at least one survey to the subset of the target market group comprises hosting the at least one survey as a webpage.

5. The method of claim 1 wherein receiving results from the testing comprises receiving survey responses to the at least one question.

6. The method of claim 5 wherein the survey responses are received over a network.

7. The method of claim 6 wherein the network comprises the Internet.

8. The method of claim 1 further comprising accessing in-market data comprising volume build information relating to other marketing messages in the same industry as the promotional item.

9. The method of claim 8 further comprising projecting the promotional item volume build due to the marketing message.

10. The method of claim 9 wherein projecting the promotional item volume build due to the marketing message comprises fitting the volume build to a linear or non-linear regression model.

11. The method of claim 1 further comprising creating an amplification tool for the promotional item, the amplification tool comprising advertising for the promotional item.

12. The method of claim 11 wherein the amplification tool is selected from the group consisting of stickers, samples of the promotional item, postcards, flyers, clothing, and jewelry.

13. The method of claim 11 further comprising delivering the amplification tool to the subset of the target market group.

14. The method of claim 1 wherein the at least one score is indicative of the marketing message's ability to generate word of mouth.

15. The method of claim 1 further comprising refining the at least one marketing message based at least in part on the value of the at least one score.

16. A method for predicting the efficacy of a marketing campaign, the method comprising:
receiving an indication of a target market group to market a promotional item;
enrolling individuals within the target market group, wherein enrolling individuals comprises receiving data relating to the social networks of the individuals;
generating a survey comprising at least one question relating to a marketing message associated with the promotional item;
receiving survey responses from the enrolled individuals; and
analyzing the received survey responses, wherein analyzing the received survey responses comprises calculating at least one score for at least one attribute of the marketing message, the at least one score derived at least in part from the received survey responses.

17. The method of claim 16 wherein the at least one attribute is selected from the group consisting of purchase intent, message advocacy, and message amplification.

18. The method of claim 16 wherein calculating the at least one score comprises calculating the number of received survey responses.

19. The method of claim 16 wherein calculating the at least one score comprises assigning weights to answer choices of the at least one question.

20. A system for predicting the efficacy of a marketing campaign, the system comprising:
memory to store at least one survey related to a marketing message; and
a server coupled to the memory, the server configured to:
receive an indication of a target market group to market a promotional item associated with the marketing message;
generate the at least one survey, wherein the at least one survey comprises at least one question relating to the marketing message;
receive responses to the at least one survey from individuals within the target market group;
store the received responses in the memory; and
calculate at least one score for at least one attribute of the marketing message, the score derived at least in part from the received survey responses.
